(19) United States
(12) Patent Application Publication
(10) Pub. No.: US 2013/0245181 A1
(43) Pub. Date: Sep. 19, 2013

(54) SILICONE COMPOSITION WITH IMPROVED MECHANICAL PROPERTIES

(71) Applicant: SIKA TECHNOLOGY AG, Baar (CH)

(72) Inventors: Manuel FRIEDEL, Zurich (CH); Michael BOTTIGER, Rudolfstetten (CH)

(73) Assignee: SIKA TECHNOLOGY AG, Baar (CH)

(21) Appl. No.: 13/747,173

(22) Filed: Jan. 22, 2013

(30) Foreign Application Priority Data
Mar. 19, 2012 (EP) EP12160125.6

(51) Int. Cl. C08K 5/56

(52) U.S. Cl. CPC C08K 5/56
USPC 524/400

(57) ABSTRACT

The present invention relates to a silicone composition, including at least one addition or condensation curable polydiorganosiloxane with a viscosity of 10 to 500,000 MPa at a temperature of 23° C., at least one curing agent for the polydiorganosiloxane, at least one organotin compound, at least one complex of an element selected from the groups 4, 10, 12, 13 and 15 of the periodic system of elements, at least one silica acid with a BET surface of 50 to 300 m²/g, as well as at least one chalk with a BET surface of 10 to 25 m²/g and an average particle size d50 of 10 to 1000 nm. Such compositions are particularly suitable as adhesives, sealants, coatings or pouring compounds and are characterized by high tear propagation resistances.

### TECHNICAL FIELD

The present invention relates to the field of silicone compositions, especially their use as adhesives and sealants.

### PRIOR ART

Silicone compositions have already been known for a long time; they are used in particular as adhesives and sealants in various applications. In this context, both single-component, moisture-curing silicone compositions as well as also two-component silicone compositions that cure at room temperature are widespread.

Since silicone compositions are frequently used in the building industry, they have to comply with special regulations with respect to their properties, in particular the mechanical properties. In Switzerland, for example, such regulations are issued by the Federal Office for Public Safety. Among other things, certain requirements with respect to the tear propagation resistance of the silicone composition are also specified, inasmuch it is known that particularly silicone compositions have relatively low tear propagation resistances.

EP0649879 discloses silicone compositions, which contain a specific filler combination of hexamethyldisilazane surface-modified precipitation silica and precipitated calcium carbonate coated with stearate as well as a tin catalyst. By using these very specific fillers, the tear propagation resistance of the silicone composition can be improved.

The disadvantage of compositions pursuant to EP0649879 is that these specific fillers are complicated to produce and are therefore expensive.

### REPRESENTATION OF THE INVENTION

The object of the present invention therefore is to provide a silicone composition with improved tear propagation resistance which can also be realized with conventional, economical fillers.

Surprisingly it was found that silicone compositions pursuant to claim 1 solve this problem.

By using a catalyst or acceleration system of an organotin compound as well as from at least one complex of an element selected from the groups 4, 10, 12, 13 and 15 of the periodic system of elements, it is possible to improve the tear propagation resistance of the silicone composition using a filler combination from at least one silica with a BET surface of 50 to 300 m²/g as well as from at least one chalk with a BET surface of 10 to 25 m²/g and an average particle size d50 of 10 to 1000 nm. In this context, the fillers used do not have to be pretreated using costly methods or be coated.

Further aspects of the invention are the subject of further independent claims. Particularly preferred embodiments of the invention are subject of the dependent claims.

### WAYS FOR IMPLEMENTING THE INVENTION

The present invention relates to a silicone composition comprising
at least one addition or condensation curable polydiorganosiloxane with a viscosity of 10 to 500,000 MPa at a temperature of 23° C.,
at least one curing agent for the polydiorganosiloxane,
at least one organotin compound,
at least one complex of an element selected from the groups 4, 10, 12, 13 and 15 of the periodic system of elements,
at least one silica with a BET surface of 50 to 300 m²/g, as well as
at least one chalk with a BET surface of 10 to 25 m²/g and an average particle size d50 of 10 to 1000 nm.

Any substance names starting with “poly,” such as polyol, for example, in the present document indicate substances which formally contain two or more of the functional groups per molecule in their name. In the present document, the term “polymer” comprises on the one hand a collective of chemically uniform macromolecules, but which differentiate with reference to the degree of polymerization, molar weight and chain length, which was produced by a polyreaction (polymerization, polyaddition, polycondensation). On the other hand, the term also includes derivatives of such collective of macromolecules from polyreactions, i.e. compounds which were obtained by additions or substitutions of functional groups of specified macromolecules, for example, and which can be chemically uniform or non-uniform. The term moreover includes also so-called prepolymers, i.e. reactive oligomeric prepolymers, the functional groups of which participate in the synthesis of macromolecules.

The polydiorganosiloxane in the silicone composition as taught by the invention is in particular a vinyl-terminated polydiorganosiloxane or a polydiorganosiloxane P of formula (I).

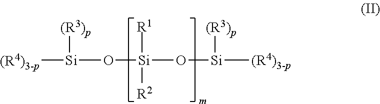

In this context, the residues R¹, R² and R³ independently of each other represent linear or branched monovalent hydrocarbon residues with 1 to 12 C atoms, which optionally comprise one or several heteroatoms and optionally one or several C—C multiple bonds and/or optionally cycloaliphatic and/or aromatic components.

The R¹ and R² residues in particular represent alkyl residues with 1 to 5, in particular with 1 to 3, C atoms, preferably for methyl groups. The R³ residues represent independently of each other in particular phenyl, vinyl, or methyl groups.

The R⁴ residues independently of each other represent hydroxyl groups or alkoxy, acetoxy or acetoxime groups with respectively 1 to 13 C atoms, which optionally comprise one or several heteroatoms, and optionally one or several C—C multiple bonds and/or optionally cycloaliphatic and/or aromatic components.

The index p represents a value of 0, 1 or 2, in particular 0 or 1. Furthermore, the index m is selected such that the polydiorganosiloxane P at a temperature of 23° C. comprises a viscosity of 10 to 500,000 MPa, in particular from 1000 to 250,000 MPa.

The polydiorganosiloxane preferably is a condensation curable polydiorganosiloxane.

If the R⁴ residues represent acetoxime groups, this preferably involves acetoxime groups with respectively 1 to 13 C atoms and the index p particularly represents a value of 0.

In this context, preferred acetoxime groups are dialkyl-acetoxime groups, the alkyl groups of which respectively comprise 1 to 6 C atoms. Preferably, both alkyl groups of the dialkyl-acetoxime groups independently of one another represent methyl, ethyl, n-propyl, isopropyl, n-butyl or iso-butyl groups. Especially preferred are such cases, in which one alkyl group of the dialkyl-acetoxime represents one methyl group and the other alkyl group of the dialkyl-acetoxime represents one methyl, ethyl or one iso-butyl group. The acetoxime group most preferably represents one ethyl-methyl acetoxime group.

The R⁴ residues preferably represent hydroxyl groups and the index p a value of 2.

Suitable polydiorganosiloxanes, such as represented particularly in formula (I), are known and commercially available. The manufacture of such polydiorganosiloxanes is also done in the known manner, such as described in U.S. Pat. No. 4,962,152, for example.

The present composition furthermore comprises at least one curing agent for the polydiorganosiloxane.

If the polydiorganosiloxane involves an addition-curable polydiorganosiloxane, in particular a vinyl-terminated polydiorganosiloxane, then the curing agent for the polydiorganosiloxane is a hydrosiloxane, a derivative thereof or a mixture of multiple hydrosiloxanes or hydrosiloxane derivatives, wherein the curing agent comprises at least two SiH groups per molecule on average. Suitable hydrosiloxanes comprise between 0.01 mmol/g and 2 mol/g H atoms relative to the weight of the hydrosiloxane. In addition, suitable hydrosiloxanes have a viscosity of between 0.1 MPa and 150,000 MPa at 25° C.

Particularly suitable curing agents are compounds of the formula (II)

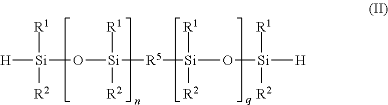

In this context, the R¹ and R² residues have been described previously. The R⁵ residue represents an oxygen atom or a monovalent hydrocarbon residue with 1 to 30 C atoms, which optionally comprises one or several heteroatoms, and optionally one or several C—C multiple bonds and/or optionally cycloaliphatic and/or aromatic components.

n and q represent independently of each other values of 0 to 20.

Curing agents which are particularly suitable are selected from the group consisting of poly(dimethylsiloxane-co-methylhydrosiloxane), tris(dimethylsilyloxy)phenylsilane, bis(dimethylsilyloxy)diphenylsilane.polyphenyl(dimethylhydrosiloxy)siloxane, methylhydrosiloxane-phenylmethylsiloxane copolymer, methylhydrosiloxane-alkylmethylsiloxane copolymer, polyalkylhydrosiloxane, methylhydrosiloxane-diphenylsiloxane-alkyl-methylsiloxane copolymer, polyphenylmethylsiloxane-methylhydrosiloxane, as well as the cyclic representatives such as tetramethylcyclotetrasiloxane and pentamethylcyclopentasiloxane.

If the polydiorganosiloxane involves a condensation curable polydiorganosiloxane, in particular a polydiorganosiloxane P of the formula (I) as described above, the curing agent for the polydiorganosiloxane is in particular a silane of the formula (III).

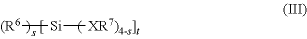

In this context, the R⁶ residue represents independently of each other a linear or branched hydrocarbon residues with 1 to 12 C atoms, which optionally comprises one or several heteroatoms, and optionally one or several C—C multiple bonds, and/or optionally cycloaliphatic and/or aromatic components.

X represents a heteroatom, particularly O or N. If X equals N, then this N in addition to R⁷ carries a hydrogen atom or an alkyl group, in particular an alkyl group with 1 to 5, in particular with 1 to 3, C atoms, preferably a methyl group. The R⁷ residue represents independently of each other a hydrogen atom, or an alkyl group with 1 to 12 C atoms, or a ketimine residue with 1 to 13 C atoms, or for an alkyl group with 1 to 12 C atoms. The R⁷ residue represents in particular an alkyl residue with 1 to 5, in particular 1 to 3 C atoms, preferably a methyl or ethyl group.

The index s represents a value from 0 to 4, wherein if s represents a value of 3 or 4, at least s-2 R⁶ residues comprise respectively at least one, in particular condensable group, which is reactive with the reactive groups of the polydiorganosiloxane P, i.e. a hydroxide group, for example. s particularly represents a value of 0, 1 or 2, preferably a value of 1. The index t represents a value of 1, 2 or 3, in particular 1 or 2.

For the selection of the silane of the formula (III) as curing agent for polydiorganosiloxanes, different requirements can be decisive for the silicone composition. On the one hand, the reactivity of the silane is very important, wherein higher reactive silanes are basically preferred.

On the other hand, toxicological reasons can also be decisive for the selection of the curing agent. For this reason, tetraethoxysilane is preferred as a curing agent, compared to tetramethoxysilane, for example.

Examples of suitable formula (III) silanes are methyltrimethoxysilane, chloromethyltrimethoxysilane, ethyltrimethoxysilane, propyltrimethoxysilane, vinyltrimethoxysilane, methyltriethoxysilane, vinyltriethoxysilane, phenyltriethoxysilane, methyltripropoxysilane, phenyltripropoxysilane, tetramethoxysilane, tetraethoxysilane, tetra-n-propoxysilane, tetra-n-butoxysilane, 2-aminoethyl-3-aminopropyltrimethoxysilane, 2-aminoethyl-3-aminopropyltriethoxysilane, N-phenylaminomethyltrimethoxysilane, 3-glycidoxypropyltrimethoxysilane, bis(N-methylacetamide)methyl ethoxy silane, tris-(methylethylketoxime) methylsilane, tris-(methylethylketoxime)vinylsilane, tris-(methylethylketoxime)phenylsilane, N,N-bis-(triethoxysilylpropyl)amine, N,N-bis-(trimethoxysilylpropyl)amine, or 1,2-bis-(triethoxysilyl)ethane.

Particularly preferred is if the silane of the formula (III) is a vinyltrimethoxysilane or tetraethoxysilane, or a mixture thereof.

The silanes can furthermore also be present as partially (a part of all R⁷=H) or completely hydrolyzed (all R⁷=H). Because of the significantly increased reactivity of partially or completely hydrolyzed silanes, it may be advantageous if they are used as curing agents. Those skilled in the art know that if partially or completely hydrolyzed silanes are used for the formation of oligomeric siloxanes, it is possible that oligomeric siloxanes are formed, in particular dimers and/or trimers, which are formed by the condensation of hydrolyzed silanes. According to this, even oligomeric siloxanes can be used as curing agents for the two-component silicone compositions.

Suitable oligomeric siloxanes, for example, are hexamethoxydisiloxane, hexaethoxydisiloxane, hexa-n-propoxydisiloxane, hexa-n-butoxydisiloxane, octaethoxytrisiloxane, octa-n-butoxytrisiloxane and decaethoxytetrasiloxane.

Obviously, also any mixture of the above-mentioned silanes can be used as a two-component curing agent.

The percentage of the curing agent for polydiorganosiloxanes is preferably 0.1 to 15 percent by weight, in particular 1 to 10 percent by weight, preferably 2 to 5% by weight, of the total silicone composition.

The silicone composition as taught by the invention moreover comprises at least one organotin compound.

Preferred organotin compounds are dialkyltin compounds, such as they are selected for example from the group consisting of dimethyltin di-2-ethylhexanoate, dimethyltin laurate, di-n-butyltin diacetate, di-n-butyltin acetylacetonate, di-n-butyltin dioxide, di-n-butyltin di-2-ethylhexanoate, di-n-butyltin dicaprylate, di-n-butyltin di-2,2-dimethyloctanoate, di-n-butyltin dilaurate, di-n-butyltin-distearate, di-n-butyltin dimaleate, di-n-butyltin dioleate, di-n-octyltin diacetate, di-n-octyltin acetylacetonate, di-n-octyltin dioxide, di-n-octyltin di-2-ethylhexanoate, di-n-octyltin di-2,2-dimethyloctanoate, di-n-octyltin dimaleate and di-n-octyltin dilaurate.

In certain cases, it is obviously possible or even preferable, to use mixtures of different organotin compounds.

The percentage of the organotin compound is preferably 0.001 to 1 percent by weight, in particular 0.005 to 0.1% by weight of the total silicone composition.

The silicone composition as taught by the invention comprises moreover at least one complex of an element selected from the groups 4, 10, 12, 13 and 15 of the periodic system of elements.

This in particular involves a complex of boron, aluminum, antimony, bismuth, titanium, zirconium, or zinc, preferably titanium or zirconium.

Particularly preferred complexes, especially those of titanium and zirconium, comprise ligands selected from the group consisting of alkoxy group, sulfonate group, carboxylate group, dialkyl phosphate group, dialkyl pyrophosphate group and acetyl acetonate group, wherein all ligands can be identical or different from one another.

Alkoxy groups, especially the so-called neo-alkoxy substituents, for example a 2.2-bis((allyloxy) methyl)butoxy substituent, were found to be especially suitable. Sulfonic acids, in particular aromatic sulfonic acids, whose aromatics are substituted with an alkyl group, were found to be particularly suitable.

Carboxylate groups, particularly carboxylates of fatty acids, were found to be particularly suitable. A preferred carboxylate is regarded to be decanoate, stearate and iso-stearate.

In particular the complex, especially the titanate or the zirconate, has at least one polydentate ligand, also called chelating ligand.

The polydentate ligand is particularly a bidentate ligand.

The bidentate ligand is preferably a ligand of the formula (IV)

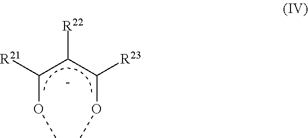

In this context, the R²¹ residue represents a hydrogen atom or a linear or branched alkyl group with 1 to 8 C atoms, particularly a methyl group.

The R²² residue represents a hydrogen atom or a linear or branched alkyl group with 1 to 8 C atoms, which possibly contains heteroatoms, in particular a hydrogen atom.

The R²³ residue represents a hydrogen atom or an alkyl group with 1 to 8, particularly with 1 to 3 C atoms, or a linear or branched alkoxy group with 1 to 8, particularly with 1 to 3, C atoms.

The complex preferably is a titanate of the formula (V).

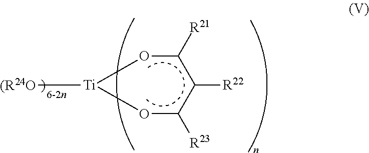

The R²¹, R²² and R²³ residues were already described above.

The R²⁴ residue represents a linear or branched alkyl residue with 1 to 20 C atoms, particularly an isobutyl or an isopropyl residue. n represents a value of 1 or 2, in particular 2.

Titanates of the formula (V) are preferred, wherein the R²¹ residue represents a methyl group, the R²² residue represents a hydrogen atom, the R²³ residue represents a methyl group or methoxy or ethoxy group, and the R²⁴ residue represents an isobutyl or an isopropyl residue.

Suitable titanates are commercially available, for example under the trade names Tyzor® AA, GBA, GBO, AA-75, AA-65, AA-105, DC, BEAT, IBAY from the Dorf Ketal company, or are commercially available from Borica under the trade names Tytan™ PBT, TET, X85, TAA, ET, S2, S4 or S6.

Suitable zirconates are commercially available, for example under the trade names Tyzor® NBZ, NPZ, TEAZ, 212, 215, 217, 223 from the Dorf Ketal company, or are commercially available from King Industries under the trade names K-Kat 4205 or K-Kat XC-6212. A suitable aluminate is available from King Industries under the trade name K-Kat 5218, for example.

Suitable bismuthates are available from King Industries under the trade names K-Kat 348 and K-Kat XC-8203, for example.

It is obviously possible, even preferred in certain cases, to use mixtures of different complexes of an element, selected from the groups 4, 10, 12, 13 and 15 of the periodic system of elements.

The percentage of the complex is preferably 0.002 to 5 percent by weight, in particular 0.005 to 3 percent by weight, preferably 0.01 to 1.5 percent by weight of the total silicone composition.

The organotin compound and the complex of an element selected from the groups 4, 10, 12, 13 and 15 of the periodic system of elements together form a catalyst or acceleration system for the curing of the polydiorganosiloxane.

The percentage of the organotin compound and of the at least one complex together is 0.005 to 7 percent by weight, particularly 0.01 to 5 percent by weight, preferably 0.02 to 2 percent by weight, based on the total silicone composition.

The ratio of the organotin compound to the complex preferably lies between 1:10 and 100:1, in particular between 1:1 and 80:1, preferably between 5:1 and 50:1 and most preferably between 10:1 and 30:1.

The silicone composition as taught by the invention moreover comprises at least one silica with a BET surface of 50 to 300 m²/g, particularly of 100 to 250 m²/g.

Suitable silicas are precipitated or pyrogenic silicas, which can be surface hydrophobized or which can be untreated, i.e. be present in the hydrophilic form.

Suitable hydrophobized silicas are typically siliconized and/or silanized silicas, which then comprise a carbon content of 0.6 to 6.5 percent by weight, based upon the total weight of the silica. However, suitable silicas can also be present untreated, i.e. hydrophilic. Furthermore, also mixtures of different silicas can be used.

The percentage of silica preferably is 1 to 35 percent by weight, in particular 3 and 30 percent by weight, preferably 5 and 25 percent by weight, particularly preferably 8 and 20 percent by weight, based on the total silicone composition.

The silicone composition as taught by the invention moreover comprises at least one chalk with a BET surface of 5 to 25 m²/g and an average particle size d50 of 10 to 1000 nm.

In this context, the particle size specification d50 is based upon the fact that 50% by weight of the particles are of a size that is equal or smaller than the value stated. The particle size d50 can typically be determined by laser light scattering in accordance with the standard ISO 13320:2009, for example with the CILAS 920 unit of the CILAS company.

Suitable chalks are natural or precipitated chalks (calcium carbonate), which are present particularly surface treated, i.e. hydrophobic. The surface treatment can be performed by treatment with fatty acids, for example, in particular stearic acid, preferably with calcium stearate. Mixtures of different chalks can obviously also be used.

The percentage of chalk preferably is 1 to 50 percent by weight, in particular 2 and 40 percent by weight, preferably 5 and 30 percent by weight, particularly preferably 7 and 25 percent by weight, based on the total silicone composition.

The silica and the chalk are used as fillers in the silicone composition as taught by the invention. The fillers influence both the rheological characteristics of the uncured composition as well as the mechanical characteristics and the surface quality of the cured composition.

The total quantity of filler in the silicone composition is typically in the range from 10 to 70 percent by weight, particularly 15 to 60 percent by weight, preferably 30 to 60 percent by weight.

The silicone composition as taught by the invention can still contain further constituents, if necessary.

Such additional constituents are particularly softeners, further fillers, hardening accelerators, pigments, adhesion promoters, processing agents, rheology modifiers, stabilizers, dyes, inhibitors, heat stabilizers, antistatics, flame retardants, biocides, waxes, flow improvers, thixotropic agents and further conventional raw materials and additives known to a person skilled in the art.

When using such optional constituents, it is advantageous to select all named constituents which may be present in the silicone composition such that the storage stability of the silicone composition will not be affected negatively by the presence of such constituent, i.e. that the characteristics of the composition, in particular the application and curing characteristics, do not change or only very little during storage. This necessitates that any reactions resulting in the chemical hardening of the described silicone composition do not occur to a significant extent during the storage. For this reason, it is particularly advantageous that the aforementioned constituents do not contain any water or only traces at most, or that water can be released during storage. For this reason it can be sensible if certain constituents are chemically or physically dried prior to mixing them into the composition.

Suitable softeners for the silicone composition as taught by the invention are particularly trialkylsilyl terminated polydialkyl siloxanes, in particular trimethylsilyl terminated polydimethyl siloxanes. Trimethylsilyl terminated polydimethyl siloxanes with viscosities between 1 and 10,000 MPa are preferred. Particularly preferred are viscosities between 10 and 1000 MPa. But is also possible to use trimethylsilyl terminated polydimethyl siloxanes, in which some of the methyl groups are replaced by other organic groups such as phenyl, vinyl or trifluoropropyl. Although linear trimethylsilyl terminated polydimethyl siloxanes are preferably used as softeners, even such compounds that are branched can be used. Instead of polysiloxane softeners, it is also possible to use organic compounds, such as certain hydrocarbons or their mixtures, as softeners. Such hydrocarbons can be aromatic or aliphatic. During the selection, particular attention must be paid that these hydrocarbons have low volatility and sufficient compatibility with the other constituents of the silicone composition.

The percentage of the softener is preferably 2 to 15 percent by weight, in particular 5 to 10 percent by weight of the total silicone composition.

Alkoxy silanes, which are preferably substituted with functional groups, are particularly suitable as adhesion promoters. The functional group is an aminopropyl, glycideoxypropyl or mercaptopropyl group, for example. Amino functional groups are preferred. The alkoxy groups of such silanes are mostly a methoxy or ethoxy group. Aminopropyltrimethoxysilane, 3-aminopropyltriethoxysilane, 3-(2-aminoethyl)-aminopropyltriethoxysilane and 3-mercaptopropyl-triethoxysilane are particularly preferred. It is also possible to use a mixture of adhesion promoters. Further suitable adhesion promoters are also amino functional alkylsilsesquioxanes such as amino functional methylsilsesquioxanes or amino functional propyl silsesquioxanes, alkoxylated alkene amines, especially ethoxylated and/or propoxylated and/or propoxylated alkene diamine, as well as further, particularly substituted oligomers, polymers and copolymers based upon polyalkylene glycols.

It will be clear to one skilled in the art that during the use of silanes as adhesion promoters there is a possibility that these can be present partially or completely hydrolyzed, depending on the conditions, such as if moisture is present. One skilled in the art furthermore knows that if such partially or completely hydrolyzed silanes are present, it is possible that as a result of condensation reactions, oligomeric siloxanes, in particular dimers and/or trimers, can be formed.

The percentage of the curing agent is preferably 0.1 to 15 percent by weight, in particular 1 to 10 percent by weight, preferably 1 to 5 percent by weight, of the total two-component silicone composition.

The silicone composition as taught by the invention can be developed as a single-component or two-component composition.

If it concerns a single-component silicone composition, it is particularly constituted such that it will cure under the influence of heat or of moisture. The most preferred single-component silicone compositions cure at room temperature under the influence of moisture, particularly of air moisture, wherein the curing occurs through condensation of silanol groups under the formation of siloxane bonds.

If the silicone composition is a two-component composition, then it will in particular be a two-component silicone composition consisting of a component A and a component B, wherein the polydiorganosiloxane, the curing agent and the catalyst or accelerator system from the organotin compound and complex are apportioned to both components such that the curing action starts only during or after the mixing of the two components.

The two-component silicone composition particularly consists of a component A, comprising
the at least one addition or condensation curable polydiorganosiloxane with a viscosity of 10 to 500,000 MPa at a temperature of 23° C.,
the at least one silica with a BET surface of 50 to 300 m²/g, as well as
the at least one chalk with a BET surface of 10 to 25 m²/g and an average particle size d50 from 10 to 1000 nm;
   and a component B, comprising
the at least one curing agent for the polydiorganosiloxane,
the at least one organotin compound,
the at least one complex of an element selected from the groups 4, 10, 12, 13 and 15 of the periodic system of elements.

Both component A as well as component B of the described two-component silicone composition are produced and stored under the exclusion of moisture. If the two components are separate from one another, they have storage stability, i.e. if they are in a suitable packaging or arrangement, they can be stored for a period of several months up to one year and longer, without that the application properties or their properties following curing change to a relevant degree for their use. The storage stability is normally determined by measuring the viscosity or the reactivity over time.

During the application of the two-component silicone composition, the components A and B are mixed with each other, for example by stirring, kneading, rolling or suchlike, however particularly by means of a static mixer, which results in the curing of the composition. The curing of the two-component silicone composition occurs particularly at room temperature. If the silicone composition as taught by the invention is a two-component silicone composition, then it is particularly used so that the weight ratio of component A to component B is >1:1, in particular from 3:1 to 15:1, preferably from 10:1 to 13:1.

During the curing of the silicone composition, reaction products of the condensation reaction are created, in particular also compounds of the formula HO—R⁴, wherein R⁴ was already described previously. Preferably these byproducts of the condensation reaction are compounds that affect neither the composition nor the substrate onto which the composition is applied. The reaction product of the formula HO—R⁴ will most preferably be a compound which easily volatilizes from the curing or from the already cured composition.

The present invention furthermore relates to the use of a silicone composition, such as described above, in the form of an adhesive, sealant, coating or as pouring compound.

The silicone composition as taught by the invention is particularly suitable for bonding, sealing or coating of substrates which are selected from the group consisting of concrete, mortar, brick, roofing tile, ceramics, gypsum, natural stone such as granite or marble, glass, vitroceramic, metal or metal alloy such as aluminum, steel, nonferrous metal, galvanized metal, wood, synthetics such as PVC, polycarbonate, polymethyl(meth)acrylate, polyester, epoxy resin, paint and varnish.

The silicone composition is preferably used in the structural area, in particular for window and facade construction.

The present invention furthermore relates to a cured silicone composition which can be obtained from a single-component silicone composition pursuant to the above description, in particular by reaction with moisture, or from a likewise previously described two-component silicone composition, by mixing the component A with the component B.

The present invention furthermore relates to the use of a filler material combination, comprising at least one silica with a BET surface from 50 to 300 m²/g as well as at least one chalk with a BET surface of 10 to 25 m²/g and an average particle size d50 of 10 to 1000 nm, together with a catalyst or accelerator system comprising at least one organotin compound as well as at least one complex of an element selected from the groups 4, 10, 12, 13 and 15 of the periodic system of elements, to increase the tear propagation resistance of silicone compositions.

It is a particular advantage of the present invention, that as of now the formulation of single and two-component silicone compositions with improved tear propagation resistance is possible, wherein as fillers both natural as well as precipitated chalks, which together with pyrogenic as well as precipitated silicas, which can be present treated or untreated, can be used. In contrast to prior art, a clearly expanded assortment of fillers, including those which are particularly economical, can be used.

### EXAMPLES

Exemplary embodiments are outlined in the following, which the described invention is intended to explain in detail. The invention is obviously not limited to these described exemplary embodiments.

### Manufacture of the Silicone Compositions

### Raw Materials Used:

OH-terminated PDMS with the viscosity of 50 Pa is available under the trade name Polymer FD 50 from the Wacker company. OH-terminated PDMS with the viscosity of 80 Pa is available under the trade name Polymer OH 0.08 from the Hanse Chemie company. (CH₃)₃Si-terminated PDMS with the viscosity of 100 MPa is available under the trade name Siliconöl [silicone oil] AK 100 from the Wacker company. Vinyl-terminated PDMS with a viscosity of 20 Pa is available under the trade name Flexosil® VinylFluid 20'000 from the BRB company. Precipitated chalk is available under the trade names Winnofil® oder Socal® from the Solvay company. Natural chalk is available under the trade names Calcilit® or Calciplast® from the Alpha-Calcit company or under the trade name Carbital® from the Imerys company. Precipitated silicas are available under the trade name Sipernat® from the Evonik company or under the trade name Zeosil® from the Rhodia company. Pyrogenic silicas can be obtained under the trade name Cabosil® from the Cabot company or under the trade name Aerosil® from the Evonik company or under the trade name of HDK® from the Wacker company.

Titanium dioxide is available under the trade name Kronos 2500 from the Kronos company. Silanes and siloxanes are available under the trade names Dynasylan® from the Evonik company or under the trade name Geniosil® from the Wacker company. Organotin compounds are available under the trade name TIB Kat® from the TIB company. Titanates and zirconates are available under the trade name Tyzor® from the Dorf Ketal company. Carbon black is available under the trade name Monarch® from the Cabot company or under the trade name Printex® from the OrionCarbon company.

To produce component A of the two-component silicone composition, the constituents listed in Table 1 were mixed and stirred in the indicated proportions by weight in a dissolver at room temperature under an inert atmosphere, until a macroscopic homogenous paste was obtained.

The following components were produced as the component B:

Component B1: In a dissolver, at room temperature, 34.7 percent by weight of a vinyl-terminated polydimethyl siloxane with a viscosity of 20,000 MPa, 20 percent by weight tetraethyl orthosilicate, 6 percent by weight of a polysilicic acid ethyl ester with an average molar mass of approximately 800 g/mol, 6 percent by weight octyltrimethoxysilane, 2 percent by weight diiso-butoxy-bis(ethyl acetate) orthotitanate, 1.3 percent by weight di-n-octyl tin acetyl acetonate, a 10 percent by weight 2-(aminoethyl)-3-aminopropyltriethoxysilane, 5 percent by weight of a hydrophobic, pyrogenic silica with a BET surface of 150 m²/g and a carbon content of approximately 2.8 percent by weight, which was pre-dispersed in a vinyl-terminated polydimethylsiloxane as well as 15 percent by weight of a carbon black with a BET surface of 84 m²/g and a primary particle size of 27 nm (weight percentages refer to the total mix in each case), were mixed until a macroscopic homogenous paste was obtained.

Component B2: In a dissolver, at room temperature, 36 percent by weight of a vinyl-terminated polydimethyl siloxane with a viscosity of 20,000 MPa, 20 percent by weight tetraethyl orthosilicate, 6 percent by weight of a polysilicic acid ethyl ester with an average molar mass of approximately 800 g/mol, 6 percent by weight octyltrimethoxysilane, 2 percent by weight di-n-octyl tin acetyl acetonate, 10 percent by weight 2-(aminoethyl)-3-aminopropyltriethoxysilane, 5 percent by weight of a hydrophobic, pyrogenic silica with a BET surface of 150 m²/g and a carbon content of approximately 2.8 percent by weight, which was pre-dispersed in a vinyl-terminated polydimethylsiloxane as well as 15 percent by weight of a carbon black with a BET surface of 84 m²/g and a primary particle size of 27 nm (weight percentages refer to the total mix in each case), were mixed until a macroscopic homogenous paste was obtained.

Component B3: In a dissolver, at room temperature, 34.7 percent by weight of a vinyl-terminated polydimethyl siloxane with a viscosity of 20,000 MPa, 20 percent by weight tetraethyl orthosilicate, 6 percent by weight of a polysilicic acid ethyl ester with an average molar mass of approximately 800 g/mol, 6 percent by weight octyltrimethoxysilane, 2 percent by weight tetra n-propyl ortho zirconate, 1.3 percent by weight di-n-octyl tin acetyl acetonate, 10 percent by weight 2-(aminoethyl)-3-aminopropyltriethoxysilane, 5 percent by weight of a hydrophobic, pyrogenic silica with a BET surface of 150 m²/g and a carbon content of approximately 2.8 percent by weight, which was pre-dispersed in a vinyl-terminated polydimethylsiloxane as well as 15 percent by weight of carbon black with a BET surface of 84 m²/g and a primary particle size of 27 nm (weight percentages refer to the total mix in each case), were mixed until a macroscopic homogenous paste was obtained.

The manufactured components A and B of the two-component silicone compositions were filled separately into cartridges, were stored sealed airtight, and were mixed together in a dissolver directly before the application at a weight ratio A:B of 13:1 as stated in Table 1, until a macroscopic homogenous paste was obtained.

As a single-component silicone composition, the constituents listed in Table 2 were mixed and stirred in the indicated proportions of weight in a dissolver at room temperature under an inert atmosphere, until a macroscopic homogenous paste was obtained.

The manufactured single-component silicone compositions were filled directly into cartridges and stored sealed airtight up to the time of application.

### Description of the Test Methods

The method for the determination of the elongation at break as well as the tensile strength as well as the manufacture of the test specimens required for that purpose, is described in ISO 527. The measurement was performed at 23° C. and 50 percent relative air humidity on a test specimen type 1B (ISO 527-2) and with a tensile velocity of 200 mm/min.

The measurement for the determination of the tear propagation resistance as well as the manufacture of the test specimens required therefore is described in DIN ISO 34-1. The measurement was performed on test specimens of Type C.

TABLE 1
Two-component silicone compositions and results

| | | 1 | 2 | 3 | 4 | 5 | 6 | 7 | 8 | 9 |
|---|---|---|---|---|---|---|---|---|---|---|
| A | OH-term. PDMS (Viscosity: | 31 | 31 | 31 | 31 | 31 | 31 | 31 | 31 | 31 |
| | 50,000 MPa) | | | | | | | | | |
| | OH-term. PDMS (Viscosity: 80 | 0.6 | 0.5 | 0.5 | 0.5 | 0.5 | 0.5 | 0.5 | 0.6 | 0.5 |
| | MPa) | | | | | | | | | |
| | (CH₃)₃Si-term. PDMS | 39 | 39 | 39 | 39 | 39 | 39 | 39 | 39.2 | 39 |
| | (Viscosity: 100 MPa) | | | | | | | | | |
| | Precipitated chalk treated with | 15.5 | 15.5 | 15.5 | 15.5 | 15.5 | | | 15.5 | 15.5 |
| | stearate (BET surface: 15-24 | | | | | | | | | |
| | m²/g) | | | | | | | | | |
| | Natural chalk treated with | | | | | | 15.5 | 15.5 | | |
| | stearate (BET surface: 10 m²/g, | | | | | | | | | |
| | d50 = 0.8 μm) | | | | | | | | | |
| | Hydrophobic, pyrogenic silica | 13.8 | | | | | | | | |
| | (BET surface: 220 m²/g, C- | | | | | | | | | |
| | content: 3-4 percent by weight) | | | | | | | | | |
| | Hydrophobic, pyrogenic silica | | 13.8 | 13.8 | | | 13.8 | 13.8 | | 13.8 |
| | (BET surface: 160 m²/g, C- | | | | | | | | | |
| | content: 2-4 percent by weight) | | | | | | | | | |
| | Hydrophobic, precipitated | | | | 13.8 | 13.8 | | | | |
| | silica (BET surface: 125 m²/g, | | | | | | | | | |
| | HMDS treated) | | | | | | | | | |
| | Hydrophilic, precipitated silica | | | | | | | | 13.5 | |
| | (BET surface: 165 m²/g) | | | | | | | | | |
| | TiO₂ (Rutil) (oil absorption | 0.2 | 0.2 | 0.2 | 0.2 | 0.2 | 0.2 | 0.2 | 0.2 | 0.2 |
| | value (ISO 787/5): 12) | | | | | | | | | |
| B | Weight ratio A:B = 13:1 | B1 | B1 | B2 | B1 | B2 | B1 | B2 | B1 | B3 |
| | Elongation at break (%) | 327 | 364 | 330 | 395 | 361 | 317 | 300 | 568 | 355 |
| | Tensile strength [MPa] | 1.6 | 1.4 | 1.1 | 1.6 | 1.5 | 1.1 | 1.0 | 2 | 1.2 |
| | Tear propagation resistance | 12 | 8 | 4 | 10 | 5 | 8 | 3 | 12 | 9 |
| | (Dye B) [N/mm] | | | | | | | | | |

TABLE 2
Single-component silicone compositions and results

| | 10 | 11 |
|---|---|---|
| (CH₃O)₂MeSi-term. PDMS | 35.3 | 35.3 |
| (viscosity: 50 Pa) | | |
| (CH₃)₃Si-term. PDMS | 21 | 21 |
| (viscosity: 1000 MPa) | | |
| Methyl silicone resin, | 1.2 | 1.2 |
| containing MeO | | |
| (viscosity: 20 MPa) | | |
| Methyltrimethoxysilane | 0.5 | 0.5 |
| Vinyltrimethoxysilane | 1.5 | 1.5 |
| Octyl phosphonic acid + | 0.3 | 0.3 |
| methyltrimethoxysilane | | |
| (1:0.75) | | |
| Di-iso-butoxy- | 1.5 | 1.5 |
| bis(ethylacetoacetato)-titant | | |
| Dioctyltin acetylacetonate | 0.2 | |
| Natural chalk, stearate | 10 | 10.7 |
| treated (BET surface: 5 m²/g, | | |
| d50 = 2 μm) | | |
| Hydrophobic, pyrogenic silica | 13.5 | 13 |
| (BET surface: 160 m²/g, C- | | |
| content: 2-4 percent by | | |
| weight) | | |
| Precipitated chalk, stearate | 15 | 15 |
| treated (BET surface: 15-24 | | |
| m²/g) | | |
| Elongation at break (%) | 550 | 450 |
| Tensile strength [MPa] | 2.3 | 2.2 |
| Tear propagation resistance | 18 | 7 |
| (Dye B) [N/mm] | | |

1. Silicone composition, comprising
at least one addition or condensation curable polydiorganosiloxane with a viscosity of 10 to 500,000 MPa at a temperature of 23° C.,
at least one cross-linking agent for the polydiorganosiloxane,
at least one organotin compound,
at least one complex of an element selected from the groups 4, 10, 12, 13 and 15 of the periodic system of elements,
at least one silica acid with a BET surface of 50 to 300 m²/g, as well as
at least one chalk with a BET surface of 10 to 25 m²/g and an average particle size d50 of 10 to 1000 nm.

2. Silicone composition pursuant to claim 1, wherein the polydiorganosiloxane is a vinyl-terminated polydiorganosiloxane or a polydiorganosiloxane P of the formula (I), 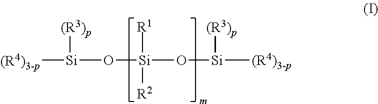
wherein
the residues R¹, R² and R³ independently of each other represent linear or branched monovalent hydrocarbon residues with 1 to 12 C atoms, which optionally comprise one or several heteroatoms, which optionally comprise one or several C—C multiple bonds and/or optionally cycloaliphatic and/or aromatic components,
the R⁴ residues independently of each other represent hydroxyl groups or alkoxy, acetyl or ketoxime groups with respectively 1 to 13 C atoms, which optionally comprise one or several heteroatoms, and optionally one or several C—C multiple bonds and/or optionally cycloaliphatic and/or aromatic components,
the index p represents the value of 0, 1 or 2; and the index m is selected such that the polydiorganosiloxane P has a viscosity of 10 to 500,000 MPa at a temperature of 23° C.

3. Silicone composition pursuant to claim 1, wherein the at least one complex is a complex of boron, aluminum, antimony, bismuth, titanium, zirconium or zinc.

4. Silicone composition pursuant to claim 3, wherein the complex is a complex of titanium or zirconium.

5. Silicone composition pursuant to claim 1, wherein the percentage of the organotin compound and the at least one complex together is 0.005 to 7 percent by weight, based upon the total silicone composition.

6. Silicone composition pursuant to claim 1, wherein the weight ratio of the organotin compound to the complex is between 1:10 and 100:1.

7. Silicone composition pursuant to claim 1, wherein the percentage of the at least one silica acid has a BET surface of 50 to 300 m²/g 1 to 35 percent by weight, based upon the total silicone composition.

8. Silicone composition pursuant to claim 1, wherein the percentage of the at least one chalk has a BET surface of 10 to 25 m²/g and an average particle size d50 of 10 to 1000 nm 1 to 50 percent by weight, based upon the total silicone composition.

9. Silicone composition pursuant to claim 1, wherein the composition is a single-component silicone composition.

10. Silicone composition pursuant to claim 1, wherein the composition is a two-component silicone composition consisting of a component A, comprising
the at least one addition or condensation curable polydiorganosiloxane with a viscosity of 10 to 500,000 MPa at a temperature of 23° C.,
the at least one silica acid with a BET surface of 50 bis 300 m²/g, as well as
the at least one chalk with a BET surface of 10 to 25 m²/g and an average particle size d50 of 10 to 1000 nm;
and a component B, comprising
the at least one curing agent for the polydiorganosiloxane,
the at least one organotin compound,
the at least one complex of an element selected from the groups 4, 10, 12, 13 and 15 of the periodic system of elements.

11. Silicone composition pursuant to claim 10, wherein the weight ratio of component A to component B is ≧1:1.

12. A method of increasing the tear propagation resistance of a silicone composition comprising:
combining a filler material with the silicone composite, the filler material combination comprising at least one silica acid with a BET surface of 50 to 300 m²/g as well as at least one chalk with a BET surface of 10 to 25 m²/g and an average particle size d50 of 10 to 1000 nm; together with a catalyst or accelerator system comprising at least one organotin compound as well as at least one complex of an element selected from the groups 4, 10, 12, 13 and 15 of the periodic system of elements.

13. A composition selected from an adhesive, sealant, coating or pouring compound, including the silicone composition pursuant to claim 1.

14. Cured silicone composition obtainable from a single-component silicone composition pursuant to claim 9 by reaction with moisture.

15. Cured silicone composition obtainable from a two-component silicone composition pursuant to claim 10 by mixing the component A with the component B.
